(19) United States
(12) Patent Application Publication
(10) Pub. No.: US 2026/0119779 A1
(43) Pub. Date: Apr. 30, 2026

(54) Routinized Document Generation System

(71) Applicants: LELIA ADAMS, PHOENIX, AZ (US); JOHN-PAUL ADAMS, CARROLTON, TX (US)

(72) Inventors: LELIA ADAMS, PHOENIX, AZ (US); JOHN-PAUL ADAMS, CARROLTON, TX (US)

(21) Appl. No.: 18/929,600

(22) Filed: Oct. 28, 2024

(51) Int. Cl. G06F 40/103

(52) U.S. Cl. CPC G06F 40/103

(57) ABSTRACT

A method for generating a routinized document, wherein the components of the document and the refinement of such components to suit a particularity of circumstance is facilitated via code according to the teachings of this disclosure, aided by artificial intelligence or machine learning. This disclosure brings a product that is then reviewable and updatable by humans for use in specific circumstances.

### PRIOR APPLICATION

This application claims the benefit of U.S. Provisional Application No. 63/593,519, entitled “Routinized Document Generation System” filed Oct. 26, 2023 which is hereby incorporated by reference.

### BACKGROUND

Routinized documentation and the inherent particularity necessary to make such documentation meet the needs of the moment has challenged professional writers, consultants, and other professionals for quite some time. In use, each circumstance is different, and the elements needed to produce a document that speaks to the particular circumstance may be unique. Each of these circumstances call for an intake of the requisite information and the translation of such information into a document, well formatted for the routine and peculiarity of the moment. For convenience or efficiency, most writers, consultants or professionals have developed templates to facilitate the production of needed documents. In some instances, the time allocation to get an expected product to an acceptable quality limits the quantity that can be produced within a given period.

Given these challenges, the quality of the product may suffer depending on who produces the document. It is also recognizable that in some circumstances, the writer, professional or otherwise, would need to do necessary research to produce an acceptable or defensible document. Further, in some cases, there may be need to cite the sources of supporting material used to produce or support such documents to avoid ‘inventing the wheel’ in circumstances that may not call for new material or claiming ownership of what is already known. Such a demand may impact the production of a legal brief, where reference material and citations to previous legal rulings may be necessary to produce a useful document.

From the above, it is notable that what is needed in the marketplace is a process that provides a user-friendly or routinized scheme or process for creating applicable, useful, relevant and functional documents, to name a few. Such methods and products to serve that need are included in this disclosure.

### SUMMARY

In one embodiment, the present invention provides a method for generating a routinized document wherein the routinized document is generated from input by a client, such input incorporated into machine learning or artificial intelligence to produce a document for intended purpose evaluation.

### BRIEF DESCRIPTION OF THE INVENTION

The present invention discloses a method for the preparation of documents that may be formatted or seem routinized for use by secondary users, readers, government entities or others who may have a need to use such documents in their assignments. As used in the present disclosure, a user may be a writer, consultant, lawyer or other professional who needs to develop or proffer a document that fits in a particular format, wherein such document contains a set or preferred set of categories wherein content should be filtered within. As an example, in a basic form of routinized writing, the subheading or categories of Introduction, Analysis and Conclusion may make the framing for documentation. In legal practice such as Immigration law submissions, subheadings are typically occasioned to make the writing and content readily accessible. It is reasonable that a document may include subcategories under Analysis such as data, citations, links, and the like to enhance the purpose or quality of such writing. The present invention further provides a method of creating a routinized document that is tailored to fit particular circumstances and allowing for an efficient review for expected outcomes.

According to the present invention, a process or method is preferably established to provide a type of routinized document needed for a particular service. Such process may access available input material preferably suitable for incorporation into the routinized document, assessing and analyzing such material and balancing the needs for any such inclusion against the redundancy of inundating with too much information. The categorization of such input material shall preferably be tailored to meet the needs of the presented circumstance. As an example, if a legal document is desired, the process of the present invention shall cull, from presently available resources, pertinent information to meet the needs of the intended routinized document. Such culling may preferably include but not be limited to legal research material, citations from preferred sources, other everyday resources, and the like. It is reasonable in most instances to expect a rich resource of material to use as review sources for such pertinent information and determining how such material is perused for the applicable ones may demand more than just reading through each of them. A system that incorporates the use of machine learning or artificial intelligence to refine such search for the intended outcomes is provided in this disclosure.

The use of machine learning or artificial intelligence as a tool is increasingly being adapted in the sorting of available material usable in cases where routinized documents are needed but the appropriateness of these material and the particularity necessary for these outputs to be impactful and useful still leaves much to be desired. The present invention develops and employs a method of culling, collating, refining and cross-checking the content for use as a routinized document. As an example, a legal brief is a particularized document that most legal practitioners appreciate the time and energy to develop and produce for use. Using the teachings of the present invention, a legal brief or such particularized document may be created that analyzes input from the referenced subject, the legal needs of the subject, the case law applicable to that instance, the currency of such case law and the uniqueness of such circumstance.

In an embodiment of the present invention, a method of producing a document particularized to a certain circumstance is provided. The circumstance includes but is not limited to information gleaned from an intake with a client, customer, or someone similarly disposed and uses such information to determine the type of document needed. The use of artificial intelligence or machine learning to search a repository of similar circumstances, if available, is preferably performed to winnow down the stock of material useful to preferably address the need for a structure of the document to be ascertained. Those skilled in the art would conclude that it is not sufficient to draw the services of artificial intelligence or machine learning platforms for the production of useful or particularized documents. The present invention incorporates the skills and process of utilizing artificial intelligence for the discrete purpose of generating the particularized document.

As a method of the present invention, information stored in large databases or randomly associated with the process of routinization of information may be pooled to prepare intended documents. Vector databases including but not limited to web content, portable data files converted to text, or large language models of assignable information are useful to integrate into routinized information. Information useful for the present invention may include voice-to-text dictation and transcription to incorporate as routinized information. A computer-aided code is preferably introduced at specific instances with the skills and teaching of the present invention to cull, collate and discern the pertinent material for use to provide the document according to the present invention. A subsequent assessment of the material or resource culled may preferably be assessed for suitability and sufficiency to produce the document according to the present invention. If legal research material is necessary, such material may be refined and sorted to address and be applicable to the circumstance. The determination of and refinement of such document may preferably be accomplished with the aid of artificial intelligence using the process of the present invention.

The aforementioned refined material may preferably, using the method of the present invention, be incorporated to prepare or draft the initial components of the routinized document. Such drafting may be processed in several iterations, each instance addressing potential gaps in conformity to produce a draft document that best meets the circumstance intended. The number of iterations necessary to accomplish this solution depends on the propriety of the material available, the applicability to the situation and the currency of the input material, all of which may be coded into the process of the present invention to produce a desired document.

In another embodiment of the present invention, the use of artificial intelligence or machine learning preferably provides a base for data refinement, code inclusion, attendant programming and other aspects that may be incorporated into the routinized document to meet intended purpose. These may include citations for legal documents, summarization of pertinent information and sections thereof, phraseology that are particularized to meet set standards and more. In an exemplar of an embodiment of this disclosure, an immigration law advocate or professional may incorporate machine learning or artificial intelligence to explore the landscape of certain legal issues, and such information is then incorporated in the present invention to produce a routinized document that is particularized for the needs and attention of administrators and subsequent decision makers. Specialized briefs and arguments may be presented using refined coding and particularized information for subsequent administrative or related processes.

Having thus described the preferred embodiments of the present invention, those of skill in the art will readily appreciate that the teachings found herein may be applied to yet other embodiments.

What is claimed:

1. A method for generating a document, comprising:
obtaining at least an input data from a data source comprising any one or more of vector data base,
culling desired information from said data bases,
arranging or formatting said information into a desired document, wherein the desired document is presented as a routinized document.

2. The method of claim 1, wherein the input data includes voice-to-data dictation.

3. The method of claim 1, wherein the vector data base includes data from large language models.

4. The method of claim 1, wherein the data base includes information from websites.

5. The method of claim 1, wherein the routinized document is provided as a legal brief.
